(19) United States
(12) Patent Application Publication
(10) Pub. No.: US 2023/0361414 A1
(43) Pub. Date: Nov. 9, 2023

(54) Lightweight Honeycomb Structural Battery Pack

(71) Applicant: Peter Sing, McCleary, WA (US)

(72) Inventor: Peter Sing, McCleary, WA (US)

(21) Appl. No.: 17/740,038

(22) Filed: May 9, 2022

(51) Int. Cl. H01M 50/291; H01M 50/213; H01M 50/249; H01M 50/224; H01M 50/227; H01M 50/222; H01M 50/293; H01M 50/503; H01M 50/519; H01M 50/509; H01M 50/242; H01M 10/613; H01M 10/625; H01M 10/643; H01M 10/6557

(52) U.S. Cl. CPC H01M 50/291; H01M 50/213; H01M 50/249; H01M 50/224; H01M 50/227; H01M 50/222; H01M 50/293; H01M 50/503; H01M 50/519; H01M 50/509; H01M 50/242; H01M 10/613; H01M 10/625; H01M 10/643; H01M 10/6557; H01M 2220/20; B60L 50/64

(57) ABSTRACT

The premise of this invention is to simplify and improve the previous methods used for battery systems in any vehicle that relies on battery power. This new method uses a honeycomb structure, in either hexagonal, circular, rectangular, or even ovular grids. Each of these grids will house each individual battery cell. This battery pack can be used for structural purposes of the car. This could replace the chassis or become part of it. The structural battery pack can be in beam-like segments to run from one end of the vehicle to the other, either side to side or front to back. The beam-like battery pack can be diagonal if necessary. The honeycomb grid itself can be made of metal, polymer, paper, wood veneer/products, or fiberglass.

The entire negative side of the battery pack can be a conductive plate that can be embedded to connect all the negative sides of each cell. Likewise, there will be a plate on the positive side of the honeycomb grid connecting each cell's positive connection. This will create a parallel connection between all the battery cells, increasing the overall amperage. More than one of the blocks of battery cells with the parallel connection will then be connected in a series to another block of parallel battery cells. Multiple blocks can be connected to achieve the required output. Batteries can be pre-arranged before bonding. Batteries can be randomly placed. Once placed, it is bonded for additional strength.

The complete modular battery pack, with cells inserted, can be easily placed in a group. The top and bottom plates, positive and negative connectors, can be pre-wired for easy installation and the case will become part of the integral structure. The interconnected housings and honeycomb grid will be water-tight to allow the air, or coolant to pass without creating a short-circuit or other issues.

Modular battery packs have battery cells with casings which function as the sandwich core grids or you can have a flange connect each casing forming the honeycomb grid. Each flange has a hole for air or coolant to pass through for core temperature control. The combination of flange and casing will become the newest technology, the casing of the battery will form the honeycomb grid. This invention will make battery cells become lighter in weight by functioning as the sandwich structural core. It will also simplify production. Instead of making individual batteries, you can insert the core of the battery cells into the honeycomb grid, which becomes the battery casing. It will have at least one layer of sandwiched skin on both sides. The most strength will be provided by gluing. By itself, the grid is a lightweight honeycomb structure. By adding multiple battery packs, it will glue together with at least one layer of skin on each side for weather protection and strongest strength with minimum weight; due to the honeycomb grid structure and battery casing connected to form an enclosed sandwich grid without additional weight.

### BACKGROUND OF INVENTION

The grid can be integrated with the battery cells to make one large modular battery pack. The cells in the pack can run parallel, for increased amperage, and/or series, for increased voltage, and use conductive plates to connect each cell in the pack.

The battery pack will become a honeycomb type structure, but the grid shape can be hexagonal, circular, rectangular, or square. Each battery pack can be a separate unit from the honeycomb panel, they are glued into place with skin material on each side. Multiple battery packs can be joined by adhesion and/or mechanical fasteners and at least one large skin on either side, in one large panel or post and beam. The honeycomb structure will act as an insulator for the individual battery cells. If battery cells are integrated with the honeycomb grid, then the grid will become the negative connection. The positive connection will be isolated from the negative connection, which can be the grid itself (if integrated cells) or a plate. This structure, complete with all battery cells, will be a modular block that can be easily removed or replaced by removing the entire adhered skin and mechanical fasteners, if used.

The modular block cell housing can be used for the structure of the vehicle. The housing can span across the entire floor pan of the vehicle or can be in beam-like sections. The beam-like sections may provide structural support and can span from side to side, front to back or diagonally across the undercarriage of the vehicle.

Each block of parallel battery cells will be connected in series to each other, increasing the overall voltage. In doing so, the parallel cell block will be easily interchangeable in the series, instead of every battery cell individually.

The battery cell housings will be interconnected and waterproof. This allows air or coolant to pass easily through without creating a short-circuit. This will provide cooling on all sides of each battery cell.

### SUMMARY OF INVENTION

The cell housing will begin as a honeycomb-like structure, grid sections can be hexagonal, circular, ovular, or rectangular. The battery cells will then be placed into each grid section. The battery cells can even be integrated into the cell housing to save time and materials. Battery cells can be placed evenly or randomly. They can be placed by drilling holes for insertion and held in position with glue.

The housing can have a plate on the negative side and one on the positive side, allowing all the cells in the housing to run parallel. The housing will be made of metal, polymer, paper, wood products, or even fiberglass.

Multiple cell housings can be connected in series to increase the voltage output. The interconnected cell housings will be waterproof so that the coolant can pass freely and not create any short-circuits. The cooling system can also be a separate honeycomb panel, above the battery housing, that the coolant passes through. There can be many layers of battery packs, insulated panels, and cooling panels.

The cell housing can be used for structural purposes also. The cell housing can span across the entire floor pan of the vehicle or can be beam-like housings. The beam-like housings will run from either side to side, front to back, or diagonally. The housings will be modular and easily replaced. Both beam and panel housings can be used together to create additional strength and energy storage.

The honeycomb battery cell housing creates a strong platform and reduces weight at the same time. The honeycomb housing can be used as the main frame for any vehicle. This structure could be used as the frame of a bicycle, motorcycle, car, truck, airplane, or even boat. The honeycomb frame does not need to be the battery housing. The honeycomb frame can be used on vehicles with combustion engines or man powered vehicles. The honeycomb design can be filled with insulation material, such as Sing Core, U.S. Pat. No. 7,147,741, but not limited to. Other insulation materials can be applied.

The honeycomb reduces weight but increases aerodynamics, allowing electric vehicles applications to provide more power and be able to travel longer distances.

Optional provisions have been made to add a layer of insulated honeycomb core panel on the top and bottom of the battery pack to keep the battery cells cool in the summer heat and keep them warm in the winter cold. The honeycomb structure can be used on any component of the vehicle's structure, such as bumpers, door posts, roof, etc. . . . This would allow additional battery storage if desired or additional structural integrity. Anchoring points of the honeycomb structure can be reinforced with plating or blocking. Battery packs can also be placed in vertical orientation if necessary.

Modular battery pack, which contains a group of battery cells, connects to another modular battery pack as a parallel or series connection to generate desired voltage and/or amperage. Lightweight sandwich panel is composed of the honeycomb structural grid glued with at least one layer of skin material on either or both sides of the modular battery pack. To add more strength and anchor points, mechanical fasteners can be applied to fasten the lightweight sandwich skin to the modular battery pack.

The lightweight sandwich panel is made of groups of battery cells, which is organized in parallel groups and series groups, and adhered together with the skin material on both sides of the groups of battery cells; creating a lightweight honeycomb battery pack beam, post, and large panel to function as the energy storage and structure for moving vehicles.

The lightweight honeycomb structural battery pack can bear the load of the entire vehicle or can bear partial weight. Depending on design, the battery cells will provide support also. Any structural part of the vehicle can be placed with this battery lightweight honeycomb structure for additional energy storage and structural strength.

When forming the honeycomb grids, small holes can be drilled into each grid sections sidewall. These holes will allow the cooling fluid or air to pass between each battery cell. Once the honeycomb grids are formed, holes will be drilled through the center of the grid section or in the grid itself for battery placement. Battery cells can be placed in a uniform or random correlation. Batteries can be bonded with the grids for continuous grid core structure to provide the optimal lightweight honeycomb structural strength.

The honeycomb structural battery pack or honeycomb structural battery panel and post and beam can have multiple layers of skin material on both or either side(s). The inner layer(s) of skin material, on the top or bottom of the panel, can have holes matching the holes in the honeycomb grid or grid section. This can then be adhered to the surface of the honeycomb while allowing the batteries anode and cathode to be exposed; this generates additional strength across the entire honeycomb battery pack panel. Once adhered, the batteries will be locked into place. The outer layer(s) of skin material can have a conductive circuit adhered to the inner surface prior to adhering to the honeycomb battery pack panel. Alternatively, the inner surface of the outer skin(s) can be routed prior to adhering to the honeycomb battery pack panel; providing protected channels for wiring or other methods of electrical connection. Skin(s) can have small cavities to receive the batteries cathode tabs.

Skin material can be any flat structural material; veneer/plywood, veneer/plywood soaked in resin, veneer/plywood pressure treated in resin, veneer/plywood treated with fireproofing and waterproof material, veneer/plywood covered with plastic, sheet aluminum, sheet metal, plastic, etc. . . . Additionally, the skin material can be another honeycomb panel on either or both sides of the honeycomb structural battery pack. This will provide additional thermal protection as well as additional strength.

Batteries do not have to be very densely packed in the honeycomb housing; this reduces the thermal exchange between batteries as well as creates a barrier if there is an issue with a battery cell. If there is an issue with a battery cell, the outer skin can be removed to expose the battery cells needing to be replaced. The faulty cell can then be replaced, and the outer skin will be replaced and adhered to the honeycomb structural battery pack. Alternatively, the battery cell can be replaced by creating a hole in the outer skin to retrieve the faulty cell and insert a new cell. The hole can then be patched for further use. Honeycomb structural battery packs can be made in modular sections for easier repair. If there is a fault in one of the battery packs, it can be removed and replaced with ease.

Honeycomb structural battery pack can be formed to any shape needed. An example of this is to curve the structural battery pack panel to function as the wheel well of a vehicle. All honeycomb structural battery packs will have the battery cells evenly distributed and ideally placed in the lowest center of gravity possible.

Battery management system can be implanted in the interior of the honeycomb structural battery pack panel. Battery Management system can also be placed between honeycomb structural battery pack beams when applicable.

The lightweight honeycomb structural battery pack can be hollow without the internal grids to improve the coolant circulation. Structure will be achieved by the outer skins. A third skin can be implemented in between and parallel to the outer skins for additional support. Alternatively, the lightweight honeycomb structural battery pack can be hollow through most of the entire span. This method will rely on foam, metal, wood, plastic, or fiberglass blocks to provide support.

This structure can be used for a floating pontoon platform. It can be hollow inside. It could carry a motorcycle across water. It can be used to create a drone that can carry objects. It is the structure to store batteries. It can be post and beam, panel, or panel with cut-off or cut-out. This lightweight honeycomb structural battery pack can be used for any electrically powered vehicle, such as electric hoverboard, electric hydrofoil, electric skateboard, etc. . . . This invention is a method housing the battery by placing in conjunction with lightweight honeycomb core or lock in the battery perpendicularly between two skins by adhesion and opening hole(s).

### SHORT FIGURE DESCRIPTION OF DRAWINGS

FIG. 1 is a close-up top view of a section of battery cells inside the honeycomb grid.

FIG. 2 is a close-up view of a single cell inside its respective grid section, depicting where the coolant will flow.

FIG. 3 is a cross-sectional view of a single cell inside of its respective grid section, depicting where the coolant will flow.

FIG. 4 is a cross-sectional view of a complete honeycomb structure with battery cells in place, showing each layer of the complete battery pack.

FIG. 5 is a top view of the honeycomb beam structure without the battery cells.

FIG. 6 is a top view of the honeycomb beam structure with battery cells in place.

FIG. 7 is a top view of the rectangular honeycomb beam structure without the battery cells.

FIG. 8 is a top view of the rectangular honeycomb beam structure with battery cells in place.

FIG. 9 is a top view of battery cells integrated into the honeycomb grid structure.

FIG. 10 is a top view of independent battery cells inserted into the intersection of each grid.

FIG. 11 is a top view of multiple honeycomb beam structures joined together.

FIG. 12 is a top view of the honeycomb structure being used as the chassis for a four wheeled vehicle.

FIG. 13 is a top view of the honeycomb structure, with battery cells in place, being used as the chassis for a four wheeled vehicle.

FIG. 14 is a side view of the honeycomb structure replacing the common tube frame of a bicycle.

FIG. 15 is a side view of a few examples of different vehicles with the honeycomb structural battery pack in place.

### DESCRIPTION OF THE PREFERRED EMBODIMENTS

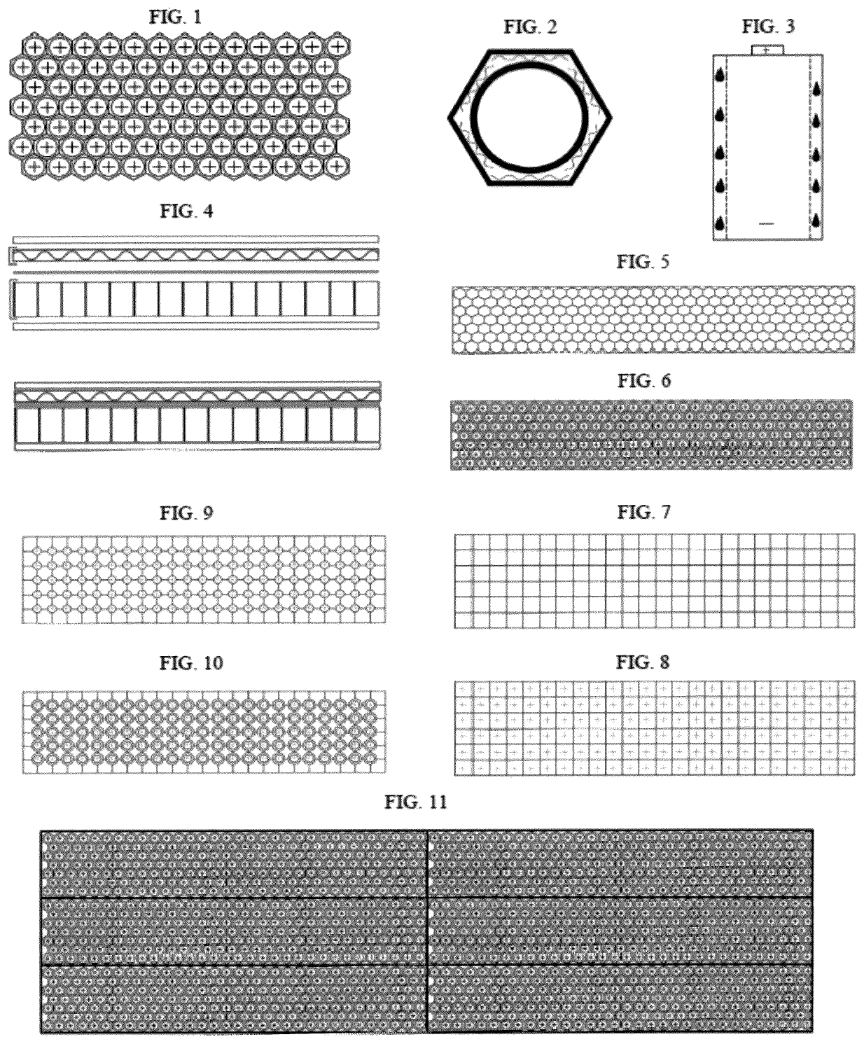

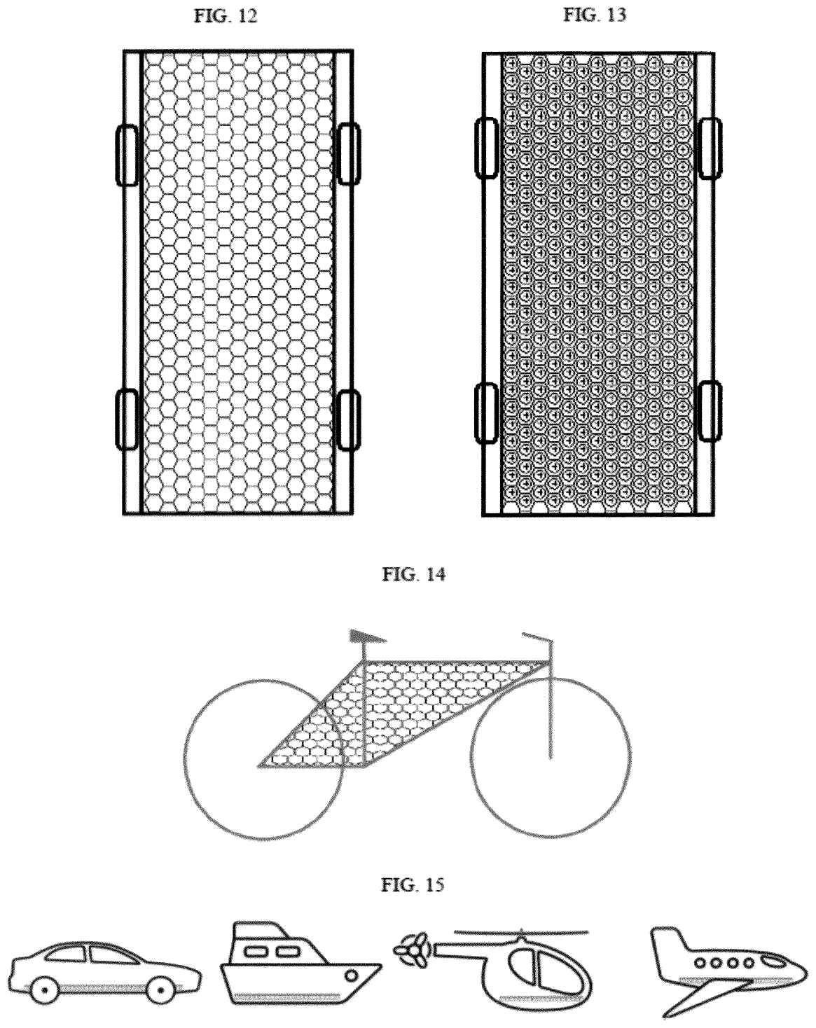

The honeycomb structural battery pack FIG. 1 uses a honeycomb design to provide structural integrity while reducing weight. The battery cells can either be placed into each grid section or they can be manufactured into place. Each grid section, when used with battery cells, will be waterproof to allow coolant to contact each side of every battery cell FIG. 2. The coolant will be in contact with the battery cell on all sides except for the top and bottom, to allow for safe electrical connections FIG. 3. The battery pack can have a second layer of honeycomb to circulate the coolant above the battery cells FIG. 4. The honeycomb structural battery pack will have a plate on the bottom, ensuring no moisture enters the cells. Above the honeycomb battery pack will be a busbar or circuit board connecting the battery cells. There can be a layer of honeycomb with only coolant above the circuitry if needed. Finally, the top layer will be a solid plate to seal the battery pack FIG. 4.

The honeycomb structure can be used by itself if needed FIG. 5. The honeycomb structural battery pack can be in beam-like sections to allow for easy replacement FIG. 6. The honeycomb grid design can be any shape needed, like rectangular FIG. 7. Any shape honeycomb design can have battery cells embedded into each grid section, creating a structural battery pack FIG. 8. Battery cells can be integrated into the intersection of each honeycomb grid FIG. 9. Battery cells can be independently placed in the intersection of the honeycomb grid FIG. 10. Multiple beam-like honeycomb structural battery packs can be joined together to supply additional charge capacity or additional voltage output FIG. 11.

The honeycomb structure can be used without the battery cells in place to provide high strength while keeping overall weight down. The honeycomb structure can be used as the main frame for any vehicle FIG. 12. The honeycomb structural battery pack can be used as the main frame in electric vehicles FIG. 13. This allows the electric vehicle to be lighter, and house more battery cells while remaining rigid.

The honeycomb structure can replace the common tube style frame of a bicycle. But if used for an electric powered bicycle, the honeycomb can house the necessary amount of battery cells to power the bicycle FIG. 14. The honeycomb structural battery pack can be used on any electrically powered vehicle FIG. 15.

What is claimed is:

1. Lightweight/honeycomb structure for use as main frame structure, post/beams, and panel for moving objects and vehicles by supporting and attaching all major components and accessories of those moving objects and vehicles. It functions as a chassis or part of the chassis. It has a rigid frame on all edges and solid anchor points at locations for securely attaching accessories, wheels, and cabins. Solid plates or blocks can be used to create secure anchoring points. The Honeycomb Structural Battery Pack is made of honeycomb grids with battery cells inserted into each individual grid structure that form the honeycomb core structure. Battery cells inside of each individual grid forms the inner core of the lightweight/sandwich panel. The honeycomb structure housing the battery cells can span across the entire floor pan of the vehicle or can be in beam-like sections. The beam-like sections can span across the vehicle from side to side, front to back, or diagonally. The beam-like sections of battery cell housing can be easily removed or replaced. Honeycomb battery cell housing structure grids can be made of metal, polymer, paper, wood products, or fiberglass. The lightweight structural strengthening honeycomb panel can be used for the main frame, without battery cells, for vehicles that use energy sources other than electricity. Insulated honeycomb structural panel can combine with at least one honeycomb panel with battery cells in place to strengthen and provide insulating qualities, such as patented Sing Core, U.S. Pat. No. 7,147,741.

2. In accordance with claim 1, The inside of lightweight/honeycomb battery panels consists of conductive plates or circuit boards placed on the positive side, connecting all positives; and on the negative side, connecting all of the negatives, making all cells connected parallel and increasing overall amperage. Each modular block of battery cells will be connected to each other in series increasing the overall voltage. Battery cell housings will be interconnected and waterproof so that air or coolant can pass around or above each cell. The top and bottom plate/circuit board can be pre-wired for simple installation. Battery cells in the pack with covers on both sides will be glued together with structural sandwich grids containing the battery cells inside of grids, which is the housing to store the batteries. This creates an enclosed honeycomb panel with battery cells inside as a modular unit. These are the components to build a larger panel by adding a large skin on both sides of multiple battery packs, creating a strong lightweight high strength sandwich lightweight panel by gluing everything together as one unit. This will become the main frame structure for the moving object and vehicle to attach and/or carry the weight of all vehicle components.

3. In accordance with claim 1, the battery casing will interconnect to each other casing to form a lightweight sandwich structural core. For inserted battery core components, the grid will function as the casing of the battery and function as a structural core grid. By adding skin on both sides of this structural core it will become lightweight sandwich panels or post and beam structures. As the major structure components of moving object and/or vehicle. This device also applies to bulkheads for boats, walls, floors and roof structures of moving objects and vehicles. Also function as an impact resistant surface, such as bumpers. Especially for vehicle roofs, floor, or side walls by using insulated honeycomb panels such as Sing Core and other cores, providing additional insulation, climate control, and sound deadening.

4. In accordance with claim 1, battery casings are interconnected by honeycomb grids, creating an enclosed structure. Each honeycomb grid wall has at least one hole to transfer coolant or air between all grid sections to aid in temperature control. Coolant systems can be provided by adding at least one honeycomb panel with the interconnected grid to provide circulation of coolant or air. This can be installed on any side of the battery pack but on top is preferred. Not only does it provide temperature control but also adds to the structural strength. Battery sandwich panel and coolant sandwich panel can be multilevel to form stronger panel, or post and beam.

5. In accordance with claim 1, battery cells can sit vertically, or perpendicular, in relation to the outer skin. Battery cells can lay horizontally, or parallel, to the outer skin. Modular battery packs can stack vertically or horizontally, preferably glued together to increase strength. Can also be bolted together. After glued, both sides with the skin provide extra strength. Glue at least two sides of the face is most essential for strength.

6. In accordance with claim 1, battery cells are sandwich between two skin are punctured and secured bonding to the panel then add circuitry form the first sandwich panel. Top and bottom can be honeycomb panel or at least one layer of skin material. Skin material can be any flat structural material; veneer/plywood, veneer/plywood soaked in resin, veneer/plywood pressure treated in resin, veneer/plywood treated with fireproofing and waterproof material, veneer/plywood covered with plastic, sheet aluminum, sheet metal, plastic, additional honeycomb panels, etc. . . . Skin can be removed, or a hole can be drilled to repair/replace faulty battery cells.
